(19) United States
(12) Patent Application Publication
(10) Pub. No.: US 2008/0208806 A1
(43) Pub. Date: Aug. 28, 2008

(54) Techniques for a web services data access layer

(75) Inventors: Ricard Roma i Dalfo, Redmond, WA (US); Constantin Stanciu, Redmond, WA (US); Rolando Jimenez Salgado, Redmond, WA (US); Satish Thatte, Redmond, WA (US); Sundar Paranthaman, Sammamish, WA (US); Rahul Kapoor, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/711,985

(22) Filed: Feb. 28, 2007

(51) Int. Cl. G06F 15/16; G06F 17/30

(52) U.S. Cl. 707/3; 709/202

(57) ABSTRACT

Techniques for a web services data access layer are described. An apparatus may comprise a client device having an application program, a data access layer, and a client data store. The data access layer may comprise a cache manager component and a queue manager component. The application program may request an operation for an office business entity, with the cache manager component to perform the operation using data stored by the client data store. The queue manager component may store the operation in an operational queue. Other embodiments are described and claimed.

### BACKGROUND

Information workers frequently create, consume and update business objects or entity data stored in line of business (LOB) systems. In some cases, this may be accomplished over a network using various web services. This may allow clients to access the entity data from different locations and from different client machines. It may be difficult, however, to discover all of the web services available in an enterprise or even what sources of data are available for creating enterprise solutions. Further, solutions to consume such services may be difficult to locate, and in many cases such solutions need to be customized for use with certain application programs thereby necessitating a change in the underlying code. In addition, such solutions typically do not offer offline and online services that are compatible with each other. Consequently, there may be a need for improved techniques to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are generally directed to techniques for managing data and operations for a line of business (LOB) system. Some embodiments in particular may be directed to performing operations for a LOB client device using data stored by a client data store (CDS) for the client device when operating in an offline mode, and synchronizing the operations with a middle-tier data store (MDS) when in an online mode. In one embodiment, for example, an apparatus comprising a client device may have an application program, a data access layer (DAL), and a CDS. The DAL may comprise a cache manager component and a queue manager component. The application program may be arranged to request an operation for an office business entity (OBE). The cache manager component may be arranged to perform the requested operation using data stored by the CDS. The queue manager may be arranged to store the operation in an operational queue. The client device may also include a synchronization agent component and a network interface, the client device to establish a network connection with a server using the network interface, and the synchronization agent component to synchronize performance of operations stored in the operational queue using data stored by a server data store via said connection. Other embodiments are described and claimed.

### BRIEF DESCRIPTION OF THE DRAWINGS

FIG. 1 illustrates one embodiment of an enterprise system.

FIG. 2 illustrates one embodiment of a data access layer.

FIG. 3 illustrates one embodiment of tables stored by a CDS.

FIG. 4 illustrates one embodiment of a first message flow.

FIG. 5 illustrates one embodiment of a second message flow.

FIG. 6 illustrates one embodiment of synchronizing operations.

FIG. 7 illustrates one embodiment of data operations in an offline mode.

FIG. 8 illustrates one embodiment of a logic flow.

FIG. 9 illustrates one embodiment of a computing system architecture.

### DETAILED DESCRIPTION

Various embodiments are directed to techniques for performing operations for a LOB client device using data stored by a CDS for a LOB client device when operating in an offline mode, and synchronizing the operations with a LOB system via mid-tier components when connected in an online mode. Mid-tier components are there to assist the calls by providing authentication (e.g. single-sign on), conflict detection services, and so forth. Queued operations are executed against the LOB system through the mid-tier. Examples of some operations typically performed by the client device includes create operations, read operations, update operations, delete operations and query operations, collectively referred to as “CRUDQ” operations. It is worthy to note that the abbreviation CRUDQ as used herein may refer to a subset of the exemplary operations listed above, and not necessarily all of the operations for each implementation.

The LOB client device implements an application framework that provides for application programs to execute one or more CRUDQ operations in an offline mode. The term “offline mode” may refer to when a client device does not have a network connection with another device, such as a server, for example. The offline mode, however, does not necessarily imply complete disconnection from the network. Offline mode also contemplates cases when there is connectivity between client and mid-tier, but the connectivity is so slow or intermittent that it is far more effective to work against the cache than directly against the service, and then let the synchronization agent take care of synchronization operations. In some cases, the offline mode may be also referred to as a “cached mode” to reflect this scenario.

Every client device maintains a local copy of the LOB data that it works with in the CDS. When a CRUDQ operation is executed, the local copy of the data is changed, and the operation is queued for later execution. The queued operations are executed when the LOB client device and the middle-tier LOB server move to an online mode where there is connectivity between the two devices. The term “online mode” may refer to when a client device does have a network connection with another device. Once in online mode, a synchronization agent component executes the operations against a LOB system. Various embodiments encompass what happens when CRUDQ operations are invoked on views, the CDS schema, and various application program interfaces (API) comprising part of a data access layer as exposed by the CDS.

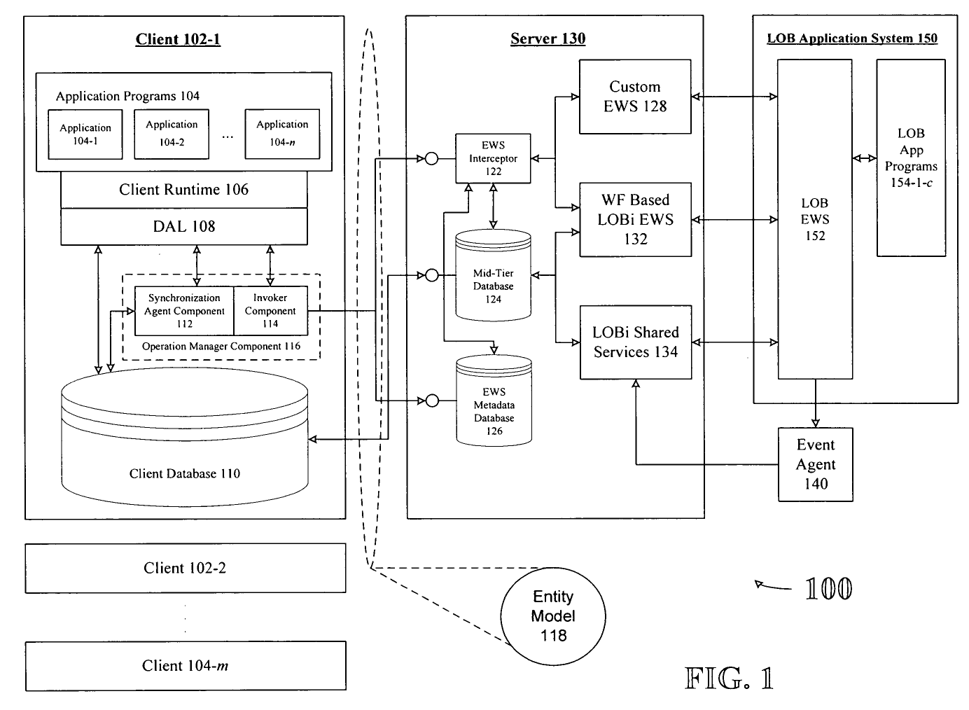

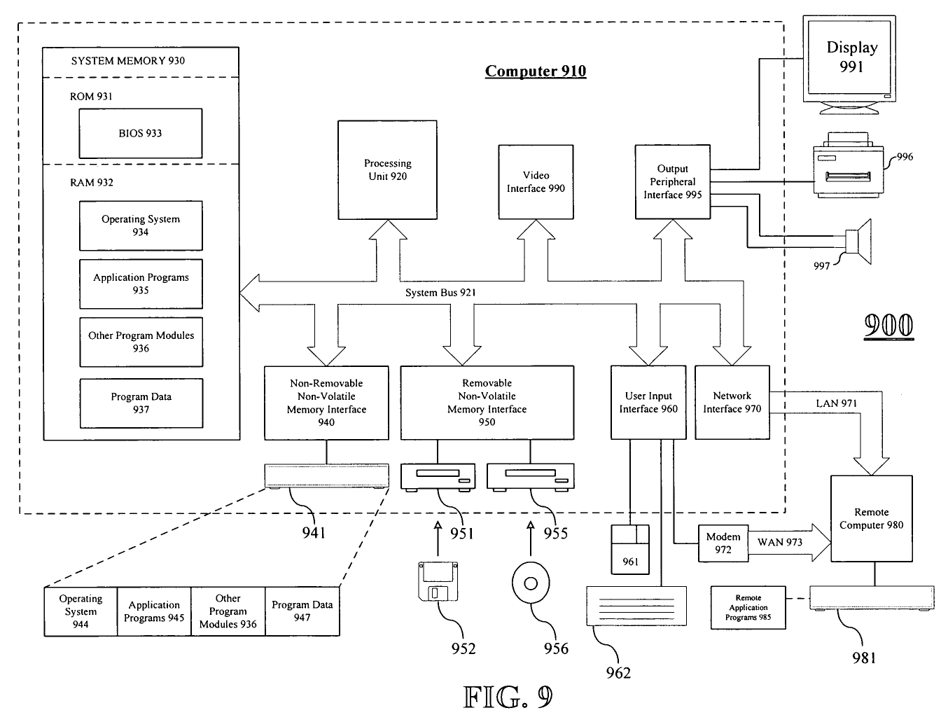

FIG. 1 illustrates one embodiment of an enterprise system 100. The enterprise system 100 may be suitable for implementing a LOB system. As shown in FIG. 1, the enterprise system 100 includes one or more clients 102-1-m, a server 130 and a LOB application system 150. It may be appreciated that the enterprise system 100 may comprise more or less elements as desired for a given implementation. It may also be appreciated that FIG. 1 also illustrates a subset of elements typically implemented for a computing device or system, and a more detailed computing system architecture suitable for implementing the clients 102-1-m, the server 130, and/or the LOB application system 150 may be described with reference to FIG. 9. The embodiments are not limited in this context.

As used herein the terms “component” and “system” are intended to refer to a computer-related entity, either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In various embodiments, the enterprise system 100 may include the LOB application system 150. The LOB application system may comprise a system composed of a business data store, a set of components that enable users to interact with the business data by enforcing business rules as dictated by the enterprise, and a set of interfaces (e.g., web services) that expose the data and business logic for programmatic access by other software applications/systems. A LOB system generally includes various LOB application programs 154-1-c typically implemented on enterprise hardware platforms for a business entity. LOB application programs 154-1-c are application programs designed to provide various business application services. Examples of LOB application programs 154-1-c may include a Customer Relationship Management (CRM) application program, an Enterprise Resource Planning (ERP) application program, a Supply Chain Management (SCM) application program, and other business application programs using business-oriented application logic. In one embodiment, for example, the LOB application programs 154-1-c may be implemented in the form of various web services, as represented by one or more LOB Enterprise Web Services (EWS) 152.

In various embodiments, the LOB application system 150 may comprise an enterprise hardware platform for a business entity suitable for storing and executing the EWS 152 to create, read, update, delete, query or otherwise process LOB data stored in an LOB system database. In addition to storing the LOB data in the LOB application system 150, the LOB data for the various LOB application programs may be stored in various elements throughout a LOB system, including a middle-tier LOB server 130 and multiple LOB client devices 102-1-m, for example. The LOB application system 150 may be implemented on any hardware and/or software platform as described for the clients 102-1-m and the server 130, as well as others. The embodiments are not limited in this context.

In various embodiments, the enterprise system 100 may include one or more servers 130. The server 130 may be communicatively coupled to the LOB system 140. The server 130 may comprise any server device or server system arranged to use or process LOB data for one or more of the EWS 152 of the LOB application system 150. Examples for the server 130 may include but are not limited to a processing system, computer, server, work station, personal computer, desktop computer, and so forth. The embodiments are not limited in this context. In one embodiment, for example, the server 130 may be implemented as a middle-tier LOB server.

In various embodiments, the enterprise system 100 may include one or more clients 102-1-m. The clients 102-1-m may comprise any client device or client system arranged to use or process LOB data for one or more EWS 152 of the LOB application system 150. Examples for client 102-1-m may include but are not limited to a processing system, computer, server, work station, appliance, terminal, personal computer, laptop, ultra-laptop, handheld computer, personal digital assistant, consumer electronics, television, digital television, set top box, telephone, mobile telephone, cellular telephone, handset, wireless access point, base station, subscriber station, mobile subscriber center, radio network controller, router, hub, gateway, bridge, switch, machine, or combination thereof. In one embodiment, for example, a client 102-1-m may be implemented as an LOB client device, application or system. A more detailed block diagram for the clients 102-1-m may be provided with the client 102-1. It may be appreciated that the various elements provided with the client 102-1 may apply to any of the other clients 102-2-m as desired for a given implementation.

In various embodiments, the client 102-1 may include one or more application programs 104-1-n. An application program may comprise any program that interacts with the business data for which LOBi enables client-side access, regardless of the author of the application program or the main function or purpose of the application program. Examples of the application programs 104-1-n may include but are not limited to application programs that are part of a MICROSOFT® OFFICE suite of application programs, such as a MICROSOFT OUTLOOK application program, for example. The MICROSOFT OUTLOOK application program is a personal information manager. Although often used mainly as an electronic mail (email) application, it also provides other application services such as calendar, task and contact management, note taking, and a journal. Application programs 104-1-n can be used as stand-alone applications, but can also operate in conjunction with server-side applications such as a MICROSOFT EXCHANGE server, to provide enhanced functions for multiple users in an organization, such as shared mailboxes and calendars, public folders and meeting time allocation. Client data for the MICROSOFT OUTLOOK application program may be stored in an OUTLOOK client database or data store (not shown).

In various embodiments, the client 102-1 may include a client runtime 106. Client runtime 106 may represent a runtime library. A runtime library is a collection of utility functions which support a program while it is running, working with the operating system to provide facilities such as mathematical functions, input and output. These make it unnecessary for programmers to continually rewrite basic capabilities specified in a programming language or provided by an operating system.

In various embodiments, the client 102-1 may include the CDS 110. The CDS 110 may comprise a data store for client side cached data. In one embodiment, for example, the CDS 110 may store client side cached LOB data that mirrors the LOB data stored by the middle-tier LOB server 130 and/or the LOB application system 150. The CDS 110 may also store an operational queue to store operations executed by the client 102-1 in an offline mode, and a state for each operation or set of operations. Further, the CDS 110 may store various tables for a given data schema, such as a mapping table for correlation IDs and entity IDs that may be useful when performing offline operations and synchronizing online operations. The CDS 110 may maintain this information as part of a Structured Query Language (SQL) database. SQL is a computer language used to create, modify, retrieve and manipulate data from relational database management systems. In one embodiment, for example, the CDS 110 may be implemented as an SQL Express database, having such features as query and table level notification support via a service broker, various “Max” types such as NVARCHAR(MAX) and VARBINARY(MAX), clustered indices, stored procedures, Extensible Markup Language (XML) data types with index and XQuery support, and an encryption key store. In one embodiment, for example, the CDS 110 may implement a single physical database per user for security reasons, as described later.

In various embodiments, the client 102-1 may include a data access layer (DAL) 108. The DAL 108 may represent an abstraction layer comprising a collection of public interfaces (e.g., APIs) to allow LOB clients to produce and consume office business entity (OBE) data maintained by the LOB application system 150. The LOB application system 150 may comprise various LOB application programs collectively referred to as EWS 152. The OBE data may include fragmented business entity data, heterogeneous interfaces and data formats, disconnected applications, and otherwise data of questionable quality. The DAL 108 provides an abstraction layer over the definition of unknown LOB operations modeled as business entities.

In various embodiments, the DAL 108 will provide several advantages to LOB data consumers and developers. For example, the DAL 108 may provide discovery of available cached entities maintained by the CDS 110. The DAL 108 may provide details about each entity with respect to entity properties, CRUDQ operations, non-CRUDQ operations, and Uniform Resource Identifiers (URIs). The DAL 108 may also allow custom proxy generation for a office business application (OBA) developer thereby making it easier to access the entity model definitions and associated operations. During runtime, the DAL 108 may provide several advantages, such as assisting in resolving the execution of operations given a unified method invocation, allowing the invocation of stereotyped operations that are mapped to real and unknown services in the back end LOB application system 150, providing transparent support for caching while remaining agnostic regarding a data source for the information, providing caching and queuing capabilities, providing query capabilities of the cached entities and conflict resolution mechanisms, providing notification about data being updated on backend systems, and performing forced refresh of an entity on the cache.

Referring again to the LOB application system 150 to further described various advantages provided by the DAL 108, the LOB application system 150 exposes various types of business process functionality in the form of EWS 152. Business processes depend on business entities that interact in some way to achieve certain task. For example, a business entity such as a sales manager may create business opportunities. In another example, a business entity such as an employee may request vacation. The definition of business entities, which is composed of views, properties and operations, will be modeled and stored as web services in the middle-tier LOB server 130.

In this environment, the DAL 108 may provide several advantages to LOB data producers, consumers and application developers. For example, the DAL 108 may provide for the gathering of details of LOB metadata. The discovery and description of business entities makes sense at design time as well as runtime. This includes browsing the cached available business entities, such as for creating graphical tools as well as proxies to model business entities, for example. In order to achieve this, the tools need to know what business entities are available on the environment, how are those business entities defined, what operations are available for those entities and how does the entity relates to other entities. The DAL 108 can provide this information. In another example, the DAL 108 may be used to perform stereotyped operations (e.g., CRUDQ operations) and custom operations (e.g., non-CRUDQ) on business entities. There is a need to perform CRUDQ operations on various entities/views based on generated strong typed proxies. The DAL 108 can provide an interface to deal with these types of operations and dispatch them in a reliable manner to the middle-tier LOB server 130, and from there to the LOB application system 150. Further, the DAL 108 can allow CRUDQ operations to be performed when the end user is working in either an online mode or offline mode. Since the DAL 108 provides caching and queuing mechanism to handle both type of circumstances, such operations will be performed in a synchronous way. In yet another example, the DAL 108 may provide query capabilities for the business entities stored in the CDS 10. Users may perform filters on this information, such as timestamps, status, type of entity, and so forth. In still another example, the DAL 108 may provide for notification of changes made to entities stored by the CDS 110 via external LOB components such as the LOB application system 150. In yet another example, the DAL 108 may provide an interface to handle conflict resolution situations. After detecting a conflict, the DAL 108 may support the decision made by the end user to solve the conflict. This could occur by either keeping a local copy and replacing the LOB data, or keeping the LOB data and overwriting the local data. In still another example, the DAL 108 may be used to refresh entity information from the LOB application system 150. In yet another example, the DAL 108 may provide access to reference data in the CDS 110. The reference data may include information unrelated to a business entity but should be displayed, such as catalog information, project identifiers (ID), zip codes, state, country codes, and so forth. The DAL 108 may abstract access to the reference data. In a final example, the DAL 108 may provide transparent support for caching/offline operations.

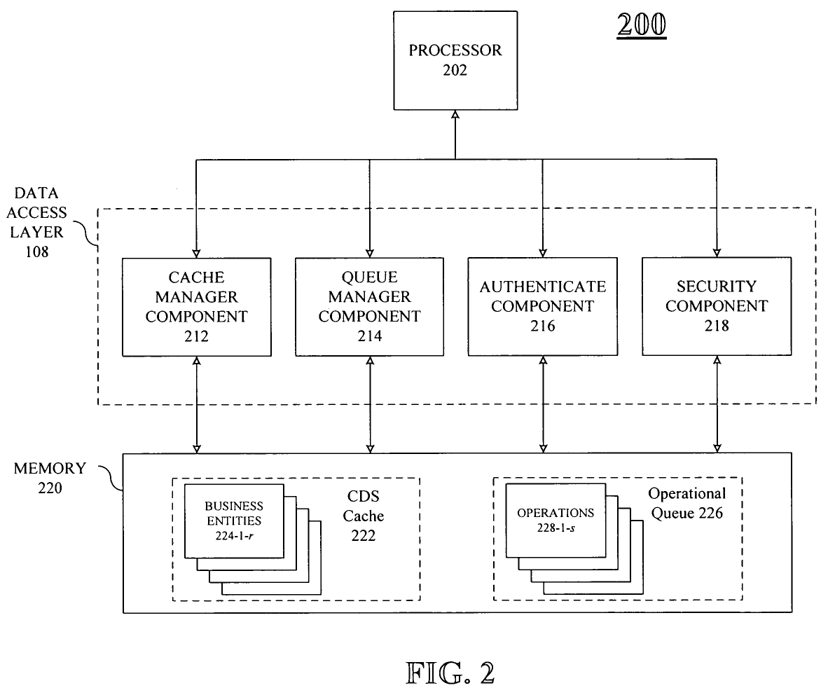

The DAL 108 may be utilized for a number of different use scenarios. For example, assume a user creates an appointment in a MICROSOFT OUTLOOK application program 104-1 that is related to a business entity. This information must be propagated to a CRM system implemented by the LOB application system 150. The DAL 108 receives an UPDATE (save) operation. The DAL 108 may invoke the appropriate API needed to perform the update to the CRM system, as well as providing information about the model and performing the synchronization. This scenario applies for all CRUDQ operations. In another example, assume a user receives an email from a customer for a service request. From within the email, the user can browse the customer information by using smart tags (e.g., READ operation). Once the information for the custom is read, the user may create an opportunity and a service request for his account (e.g., a CREATE operation) from within MICROSOFT OUTLOOK using extended items. The user may save the opportunity and these operations are propagated to the LOB application system 150. In yet another example, assume a user is at a customer site without network connectivity. Although the user is offline he is capable of reading and updating information about his customer, and creates a service request. The service request may be placed in an operational queue in order to update the CRM application once connected. In still another example, a user may be analyzing the price list for a given customer. While viewing the price list, the user may receive a notification that there is a new updated price list for his customer. In yet another example, a user may be working on an opportunity for several hours. He knows that the opportunities are updated very frequently by other team members, and he wants to make sure that he is viewing the latest information about his customer. The user may decide to refresh the account profile at any given moment to ensure his data is up-to-date. It may be appreciated that these are merely a few of the potential user scenarios, and many other use scenarios exist as well. The client 102-1 in general and the DAL 108 in particular may be described in more detail with reference to FIG. 2.

FIG. 2 illustrates a more detailed block diagram 200 of the DAL 108. As shown in FIG. 2, a processor 202 may be communicatively coupled to various components of the DAL 108. The DAL 108 may comprise, for example, a cache manager component 212, a queue manager component 214, an authenticate component 216, and a security component 218. The DAL 108 may be communicatively coupled to a memory 220, with the memory 220 including a data cache 222 having one or more entity objects models 224-1-r, and an operational queue 226 having one or more queued operations 228-1-s. The memory 220 may comprise a part of system memory (e.g., random access memory), or in some cases, the CDS 110.

In one embodiment, for example, the cache manager component 212 may be arranged to manage the data cache 222 in the memory 220 or the CDS 110. The cache manager component 212 may perform various CRUDQ operations using the business entity data 224-1-r stored by the data cache 222. For example, the cache manager component 212 may be responsible for read or write operations from view instance data tables.

In one embodiment, for example, the queue manager component 214 may be arranged to manage the operational queue 226. The operational queue 226 may store one or more operations 228-1-s. The operations may represent various CRUDQ or non-CRUDQ operations received from a LOB consumer, such as one or more application programs 104-1-m. The queue manager component 214 may enqueue and dequeue the operations 228-1-s for the operational queue 226. The queue manager component 214 may also track a state for each of the operations 228-1-s.

In one embodiment, for example, the authenticate component 212 may be arranged to authenticate a user to access data stored by the data cache 222 or the CDS 110. There is typically an instance of the CDS 110 in multiple clients 102-1-m. The LOB framework client bits are installed and the CDS 110 should enforce security per user. A user should not be able to access view instances of other users, particularly those for which they do not have the appropriate permissions. The authenticate component 212 may enforce security based on the identity of the user. For example, assume a first user has permission to view the fields on a view instance VI, but a second user does not have the same permissions. If both the first user and the second user use LOB applications in the same client device 102-1, the second user should not be able to access VI thru the data cache 222. In addition, sensitive information for a user should not be accessible even by a system administrator. This may be accomplished via the security component 218 as described later.

The authenticate component 216 may utilize different techniques to protect the data cache 222 and the CDS 110 so that users do not access unauthorized view instances. For example, different physical databases can be implemented for different users. The advantage of such an approach is it reduces or prevents large increases in database size and is constrained only by memory resources. The disadvantage of such an approach is the relative expensive setup costs since every new user will need a new database. In another example, the same physical database may be virtually divided into many databases using a table.

In the latter example, the table may have columns for user ID and every query, update and delete operations. An owner may be associated with each row. For every access, the authentication component 216 may receive a user ID with every database access, and authenticate a user based on the user ID prior to allowing access to the data stored by the appropriate rows of the table they own. The ownership may be established by storing the user ID when a row is created. In this approach, none of the users have direct access to the table and only the stored procedures have permissions to access the table. There are stored procedures for doing the CRUDQ operations on the table and all of them use the calling user ID. The stored procedures that create a row insert the user ID in the column that stores the identity. Similarly all the stored procedures that implement Read/Update and Delete queries get the user ID and use them in where clauses to ensure that just the rows that the user owns are affected. In both cases a user ID could be obtained by using a SQL function such as SUSER_SID, for example.

Both authentication approaches are effective in ensuring that the user has access to only the data they own. In the first approach of having a database per user, the framework needs to know the database that is associated with the user and a new database needs to be provisioned for every new user. In the second approach the main drawback is that all the access to the database needs to be thru stored procedures that should make sure that they use the user ID. Having all access to a database thru stored procedures may provide additional advantages such as reducing or preventing SQL injection attacks.

In one embodiment, for example, the security component 212 may be arranged to encrypt and decrypt data stored by the data cache 222 or the CDS 110. Even though the authenticate component 216 may prevent users from inadvertently accessing other user data, a malicious administrator may still be able to access sensitive data. The security component 218 utilizes an encryption/decryption technique to prevent access to sensitive contents stored in the database. Sensitive contents in the CDS 110 may include view data in the cache table and view data used in the queue table, for example.

To encrypt the contents in the CDS 110, the security component 218 may use SQL server encryption capabilities or encrypt the data before storing it in the CDS 110, and decrypt it after it is read from the CDS 110. Alternatively, the security component 218 may use a technique such as the CryptoAPI/DPAPI. The Data Protection API (DPAPI) uses the triple Data Encryption Standard (DES) algorithm for encryption. The DPAPI could be used to encrypt/decrypt the sensitive data in the CDS 110. An advantage in using DPAPI is that a key used to encrypt the data is tied to a user password, thereby reducing key management issues. A disadvantage with DPAPI, however, is that if the encrypted data has to roam, it may not be easily decrypted in the other client device since the key is stored locally as part of the profile in the client device where the data is encrypted. A feature of the MICROSOFT WINDOWS® operating system referred to as a “Roaming User Profile” may be used. The Roaming User Profile allows a user profile to be stored in a central location. When Roaming User Profile is enabled any data that was encrypted using DPAPI in one client device could be decrypted in another client device where the user is appropriately logged in.

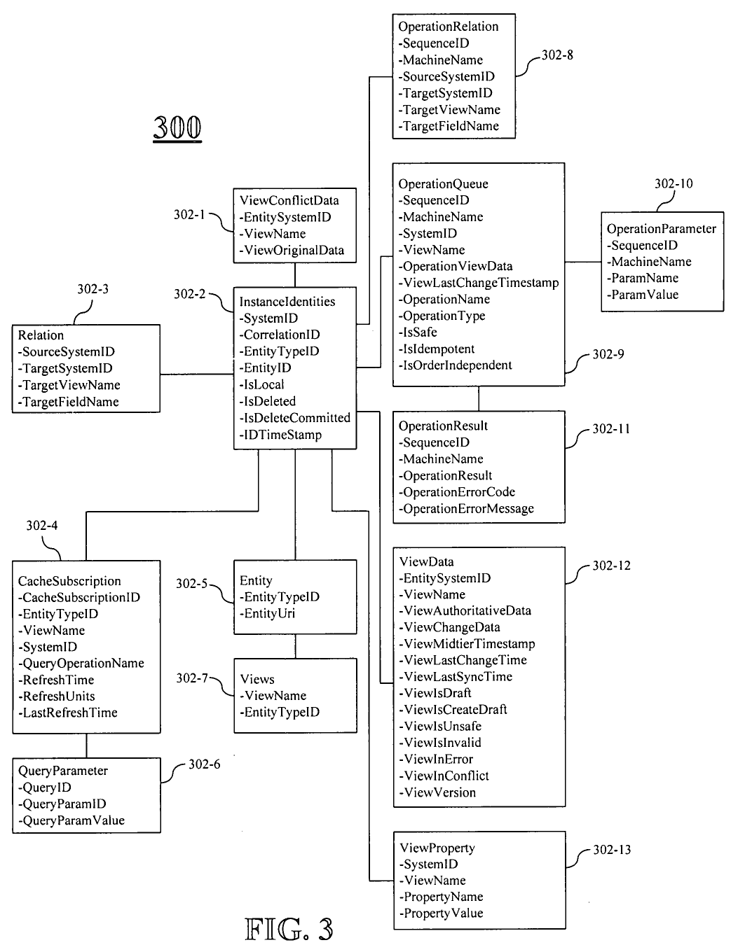

In various embodiments, the CDS 110 may be implemented as a SQL express database available in the clients 102-1-m to get offline access to data, queue operations that are to be executed against the LOB application system 150, store the state of view instances, store the application personalization settings and store the mapping from a correlation ID and an entity ID. This may be accomplished using various tables stored by the CDS 110. An example of some of the tables stored by the CDS 110 to perform these and other operations may be described with reference to FIG. 3.

FIG. 3 illustrates one embodiment of tables stored by the CDS 110. FIG. 3 illustrates an example of a CDS schema 300. As shown in FIG. 3, the CDS schema 300 may include various tables 302-1-t, with each table having various columns to store various data types, methods, fields, values, parameters, and any other information suitable for a LOB system. For example, the CDS schema 300 may include an entity table 302-5 to store the entities defined in the enterprise system 100. The CDS schema 300 may include a view table 302-7 to store the view types defined in the enterprise system 100. The CDS schema 300 may include an instance identity table 302-2 to map a correlation ID that is a temporary ID used to identify an entity before the entity is created to the entity ID which is how the entity could be identified by the middle-tier LOB server 130. The CDS schema 300 may include a relation table 302-3 to capture foreign key relationships that exist between the view instances. Foreign key relations are stored in the CDS 110 at two levels, including a table that contains all the relations at the instance level and a table that tracks the relations at the operation level. The relation table 302-3 stores the current foreign key relationships that exist on an instance. The CDS schema 300 may include a view data table 302-12 to store view instances in the CDS 110. This table may provide cached access to the data. All current view instances will be available in this table. When a view instance is read, created, updated or deleted, it will be stored in the view data table. The CDS schema 300 may include a view conflict data table 302-1 to store conflicts that happen because of changes in the LOB application system 150. The CDS schema 300 may include a view property table 302-13 to store user defined properties associated with view instances. User defined properties could be provided as part of create and update operations on view instances, and they can be read using the read operation. The CDS schema 300 may include an operation queue table 302-9 to maintain the queue of operations to be executed in the LOB application system 150. The operation queue table 302-9 will contain the list of operations both CRUDQ and non-CRUDQ that will be processed by the synchronization agent component 112 and the invoker component 114. The CDS schema 300 may include an operation relation table 302-8 to store the foreign key relationship that exists between the view instances, when the operation was queued. The CDS schema 300 may include an operation parameter table 302-10 to store the value of the parameters passed to the functions and the return values from the operations CRUDQ and non-CRUDQ. The CDS schema 300 may include an operation result table 302-11 to store the results of the operation. The CDS schema 300 may include a cache subscription table 302-4 to store the cache refresh subscriptions. The subscriptions could be of three types including OBE, view based and query based. The CDS schema 300 may include a query parameter table 302-6 to store the value of the parameters passed to cache refresh queries and non-entity cacheable read operations. The CDS schema 300 may optionally include a user settings table (not shown) to store user settings. The CDS schema 300 may include an external reference table to keep track of external associations of correlation ID to entity ID.

The CDS schema 300 allows the execution of CRUDQ operations on any instances of cacheable business data units in an offline mode. Instances of cacheable business data units may refer to any unit of business data that can be uniquely identified, stored and transferred. Examples of such instances may include entity instances and/or view instances in offline mode. When a CRUDQ operation is executed, the changes are made on the local copy of the data and the operation is queued for later execution. For example, a user could create view instances, update the view instances, delete the view instances, and read view instances. When executing these operations in an offline mode, the changes are performed locally and the operations are tracked for later execution. In this manner, a uniform behavior is presented to a user, regardless of whether they are working in an offline mode or an online mode. To accomplish this, the operations should be queued and executed when network connectivity is available. Since the operations are going to be executed against the LOB application system 150 when flushing the queue, operations are not executed in the LOB when the CRUDQ are done on view instances. Rather, the changes are made locally and the operations queued for later operation. This provides faster response times and a single code path for making calls on the LOB application system 150.

In various embodiments, the operation manager component 1116 may be used to execute stored operations when network connectivity is established in an online mode. The operation manager component 116 may accomplish this using various types of identifiers for an entity instance.

In one embodiment, for example, the operation manager component 116 may use a globally unique ID (GUID) referred to as a correlation ID. The correlation ID may represent a temporary identifier for a business entity. For example, the correlation ID is a temporary ID used to identify an entity instance before the entity is created in the LOB application system 150. The DAL 108 may identity view instances using the correlation ID. The correlation ID serves to group all operations to be done on the same view instance. A mapping from correlation ID to entity ID is stored in the CDS 110, and also for operations other than a create operation which needs an entity ID to operate. An entity ID may refer to the ID with which the LOB system recognizes or uniquely identifies a particular instance. The mapping from correlation ID to entity ID and any modifications to the view data to fix the entity ID are accomplished before executing the operations.

As opposed to the correlation ID which is temporarily used to identify the entity instance, an entity ID is a logical/meaningful ID whose value comes from the field of the entity model 118. The entity model 118 may represent a customized data model for entities stored as a structured document, such as an XML or Hypertext Markup Language (HTML) document. An entity ID along with an entity type may be used to uniquely identify an entity instance. In many cases, it is the LOB system that generates the entity ID. An entity ID, however, is not always available especially for newly created entities. The correlation ID may be used in such situations.

The correlation ID and the entity ID may be used to identify an entity instance when the client 102-1 is operating in an offline mode. For uniquely identifying an entity instance in the CDS 110, however, a field is needed to set up relationships between the appropriate tables. A system ID may be generated by the offline service components to identify the entity in tables other than ID mapping table. The various possible ID combinations may be illustrated by Table 1 as follows:

TABLE 1

| CORRELATION ID | ENTITY ID | RESULT |
|---|---|---|
| Non-NULL | NULL | The entity has been used in the system with a correlation ID and |
| | | the entity has not been created yet. |
| NULL | Non-NULL | The entity could be identified in the future using an entity ID. |
| Non-NULL | Non-NULL | The entity instance could be identified in future operations using |
| | | an entity ID or correlation ID. This entity was created by a |
| | | given client device and when the entity is created in the LOB |
| | | application system an entity ID may be generated. |
| NULL | NULL | Invalid condition regarding how the entity is known externally. |

In various embodiments, the DAL 108 may be used to create a view instance. When the DAL 108 creates a view instance, it uses a correlation ID to identify the view instance and the XML serialization of the data of the view instance. When a view instance is created, the view instance needs to be stored in the CDS 110. An entry may be created in the instance identities table, and the operation may be queued for later execution. The view instance may be stored in a view_changed_data column because the change is not yet done in the LOB application system 150. While queuing the create operation, the data may be stored in a queue_view_data column. When the create operation is picked up by the synchronization agent component 112 and executed against the LOB application system 150, and if the operation is successful, the view_changed_data is copied to the view_original_data column, and the middle-tier LOB server 130 returns the entity ID which is stored in the instance identities table.

In various embodiments, the DAL 108 may be used to update a view instance. When a view instance is to be updated, the caller passes in the correlation ID that identifies the view instance, the version of the information that they are updating (used to check if the version that they are updating is the latest) and the XML serialization of the modified data of the view instance. The view instance is first updated locally in the CDS 110 if it exists and the latest version is the version which the caller is updating. The update operation is then queued for processing by the synchronization agent component 112. As with the create operation, when the view instance is updated locally, the new data is copied to view_changed_data since the change is not yet committed in the LOB application system 150, and the version number needs to be incremented. When the update operation is picked up by the synchronization agent component 112 and successfully executed against the LOB application system 150, the view_changed_data is copied to the view_original_data.

In various embodiments, the DAL 108 may be used to delete a view instance. When a view instance is to be deleted, a caller passes in the correlation ID that identifies the view instance to be deleted. All the views of this entity instance are marked as deleted in the CDS 110 and the delete operation is queued. When the delete operation is successful, the ID mapping for this entity instance is marked as deleted.

In various embodiments, the DAL 108 may be used to read a view instance. In the case of a read operation, the DAL offers a mechanism (e.g., an Identity class) for abstracting the fact that entities may have two identifiers (e.g., a correlation Id and entity Id) at some point in time. To avoid applications having to deal with this dichotomy, the DAL provides an abstraction class that allows applications to interact with a consistent representation of the identifier. When a view instance is to be read, a caller passes in the correlation ID that identifies the view instance to be read. If the view instance is cached (e.g., available in the CDS 110), then the view instance is returned to the caller. Along with the view instance, a version number is also returned. If the view instance is not available, a request to read the view instance is queued.

When the DAL 108 executes CRUDQ and non-CRUDQ operations on view instances, it identifies them by using a correlation ID or an entity ID and the view name. Even when the DAL 108 works with the entity ID it is internally translated to a correlation ID before doing the operations locally on the cache and queuing the operation. If a view instance is identified using an entity ID when creating and reading the view instance, a new correlation ID could be generated and while updating, deleting, or performing a non-CRUDQ operation on view instances, a mapping table may be used to get the correlation ID corresponding to the entity ID.

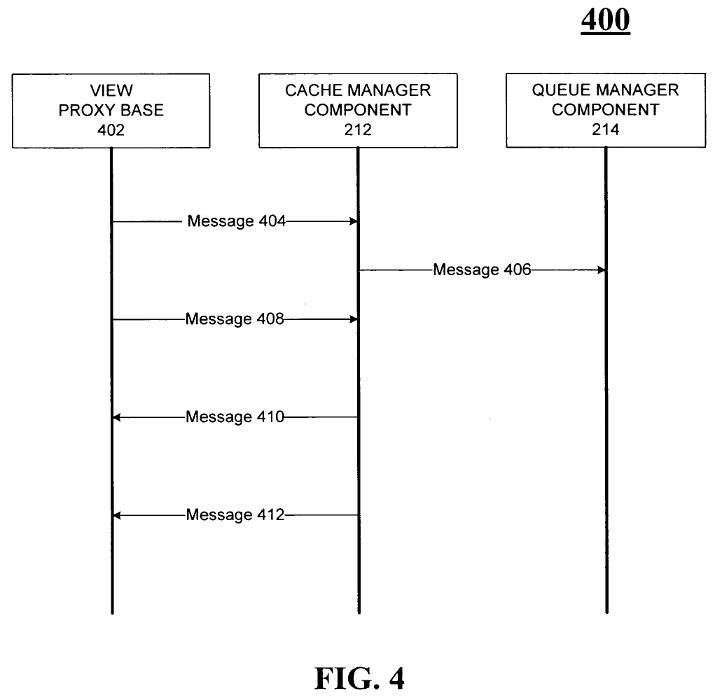

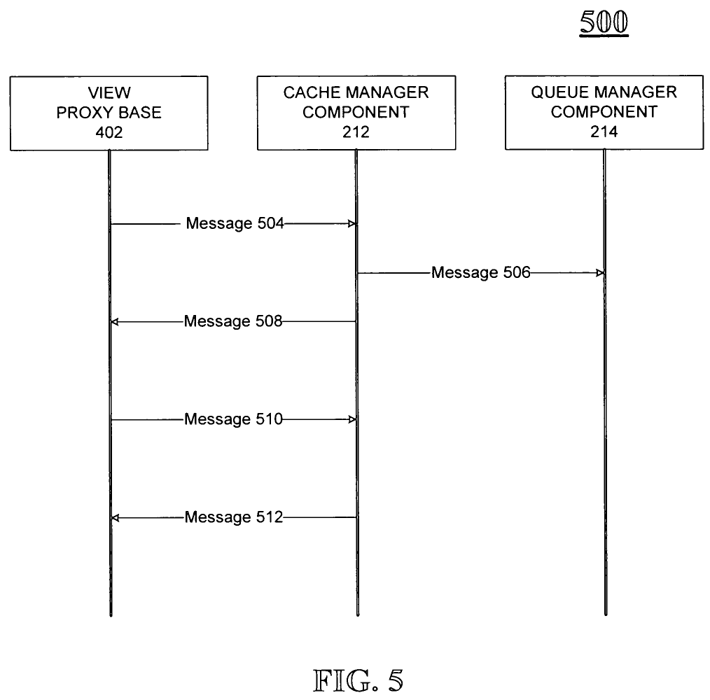

While in the offline mode, the LOB clients 102-1-m may support two different kinds of operations, including synchronous operations and asynchronous operations. For synchronous operations, the operation is executed locally, the operation is queued, and the results from local execution of the operation returned to the user. For asynchronous operations, a caller is provided with an operation ID to track the operation and the results of the operation are stored along with the operation ID. The caller could get the results of the operation by submitting a query using the operation ID. Example message flows for the synchronous operations and asynchronous operations may be further described with reference to respective FIGS. 4, 5.

FIG. 4 illustrates one embodiment of a message flow 400. Message flow 400 may provide an example of synchronous operations performed during an offline mode. As shown in FIG. 4, a view proxy base 402 may invoke a CRUDQ operation 228-1-s via message 404. The cache manager component 212 may perform the requested operation using the entity model data stored in the CDS cache 222. The cache manager component 212 may send the operation to the queue manager component 214 for placing in the operational queue 226 via message 406. The view proxy base 402 may register notification to cache manager component 212 via message 408. The cache manager component 212 may return a result notification to the view proxy base 402 via message 410. The cache manager component 212 may provide an OBE view for a read operation via message 412.

FIG. 5 illustrates one embodiment of a message flow 500. Message flow 500 may provide an example of asynchronous operations performed during an offline mode. As shown in FIG. 5, a view proxy base 402 may invoke a non-CRUDQ operation via message 504. The cache manager component 212 may perform the requested operation using the entity model data stored in the CDS cache 222. The cache manager component 212 may send the operation to the queue manager component 214 for placing in the operational queue 226 via message 506. The cache manager component 212 will return an operation ID for the non-CRUDQ operation to the view proxy base 402 via message 508. The view proxy base 402 may register notification to cache manager component 212 via message 510 using the operation ID. The cache manager component 212 may return a result notification corresponding to the operation ID to the view proxy base 402 via message 512.

In a typical implementation, CRUDQ operations are synchronous since the effect of executing the operations is defined and could be communicated to the user. Even though there is a logical difference between synchronous and asynchronous operations, they are implemented using similar processes. Operations flow synchronously from the DAL 108 to the operational queue 226 and synchronously from the operational queue 226 to the middle-tier LOB server 130. For CRUDQ operations, the results from local execution of the operations are conveyed immediately and the callers could check the results of executing the actions by identifying the entity instance. For asynchronous operations, a job ID is returned to the caller and they could find out about the results by identifying the operation thru the job ID.

Once the queue manager component 214 stores an operation in the operational queue 226 of the CDS 110, the operation manager component 116 may be used to synchronize data and invoke the queued operations against the LOB application system 150. Referring again to FIG. 1, the operation manager component 116 may comprise a synchronization agent component 112 and an invoker component 114. The synchronization agent 112 and the invoker component 114 may be communicatively coupled to a CDS 110.

The synchronization agent component 112 is the process responsible for flushing the operational queue 226 and executing CRUDQ operations against the LOB system. Optionally, the synchronization agent component 112 may also refresh the CDS cache 222 in addition to executing the queued operations. The synchronization agent component 112 is a per user process that starts on user login and keeps running to flush the operational queue 226.

The synchronization agent component 112 provides ordering of the operations in addition to providing an offline experience. For example, operations on the same entity instance will be executed in the middle-tier LOB server 130 in the order in which they are issued by the client 102-1. If the client 102-1 creates a view instance, updates the created view instance twice, performs a non-CRUDQ operation on the view instance and updates the view instance again, then the synchronization agent component 112 should execute the operations in the same order with contiguous update operations merged or collapsed. For example, the synchronization agent component 112 would create the view instance, update the view instance by combining the effects of both queued update operations, execute the non-CRUDQ operation, and finally perform the update on the view instance.

The synchronization agent component 112 flushes the operational queue 226 by grouping operations based on view instances and executing the operations in each group in the other in which they are queued. When any operation fails, all unexecuted operations in the group are marked as failures. Once a group has been processed, the synchronization agent component 112 will begin processing the next group. Since the different groups are independent of each other they could be handled using separate threads.

In some cases a foreign key relationship may exist between various entities. When there is a foreign key relationship, a create operation on the source entity could have an effect on the create operation on the target entity and therefore needs to be executed in order. The operation group needs to take care of relationships between the entities.

Two approaches are possible to mark the dependent operations as failure when an operation fails. When an operation fails, all operations on that entity are likely to fail and therefore are marked accordingly. In addition, create operations will have an effect on the operations of dependent entities. When a create fails all operations on the dependent entities should not execute. This can be enforced without explicitly marking the operations on the dependent entities that could not execute. When the create operation of an entity which is the source of a foreign key relation fails, its entity ID will not be available. For every operation there is stored the list of references that need to be fixed before the operation could be executed. A reference could be fixed only if the entity ID is available. So when a create operation fails, its entity ID will not be available and this will prevent operations on dependent entities from executing.

All operations of related entities should be included in an operation group. This could be done based on inferring the relations between the entities or making the caller specifying the relationship by grouping operations in sessions. When an operation in a session fails, all the unexecuted operations in the same session will also fail. In addition to failing the operations in the same session, all unexecuted operations on this entity instance should also be failed.

An advantage with using the sessions is that there is no needed to understand the relationship between entities while failing the operations based on the current failure. It reduces complexity during the construction of an operation group. The disadvantage using sessions is that the caller may need to group related operations. The caller needs to understand the relations between the entities and make sure they put related operations on related entities in a session. Further, even if the caller groups the operations in a session, other operations of the instances in this session should be included in the session.

In some cases, the sessions could span different invocations of the application. The sessions should include all changes performed for a particular entity instance. Each session may be given a name. Along with each operation a list of unresolved references may be stored, and when an operation fails, all the unexecuted operations on that entity instance are marked. If the failed operation is a create operation all the operations that have this entity instance as dependent cannot execute.

In various embodiments, the synchronization agent component 112 may be arranged to merge or collapse contiguous or related operations. When changes are made during an offline mode and the client 102-1 moves to an online mode, the synchronization agent component 112 combines the intermediate changes and submits only one change against the LOB application system 150. For example, delete operations and update operations could result in the merging of operations. When an operation is queued, the entity ID and the view of the entity to which this operation applies are both known. The queued operation is merged with other operations of the same entity/view instance. An example of pseudocode for a merging algorithm to merge operations may be provided as follows:

```
Get all the unexecuted operations for this entity instance sorted by
descending order of sequence id.
If the new operation is delete
Begin
  Loop until you find the end of the list
  Begin
    If this is a create operation
    Begin
      Keep track the create operation is not executed yet.
    End
    Keep track of the operation (Add the sequence id to a list)
  End
  If create operation hasn't been executed and if there are no other
operations dependent on this create
      Delete all the operations
End
Else if the new operation is update and if there aren't any parameters
for this update
Begin
    Loop until you find an operation on another view type of the entity or
end of the list or a non-CRUD operation or a create operation or
a update operation on this view with parameters
    Begin
      Delete the operation
    End
    Queue the update operation.
End
```

Delete will remove all operations on this entity instance if create has not been executed yet, and update will be merged with all the unexecuted update operations of this view type of the entity instance.

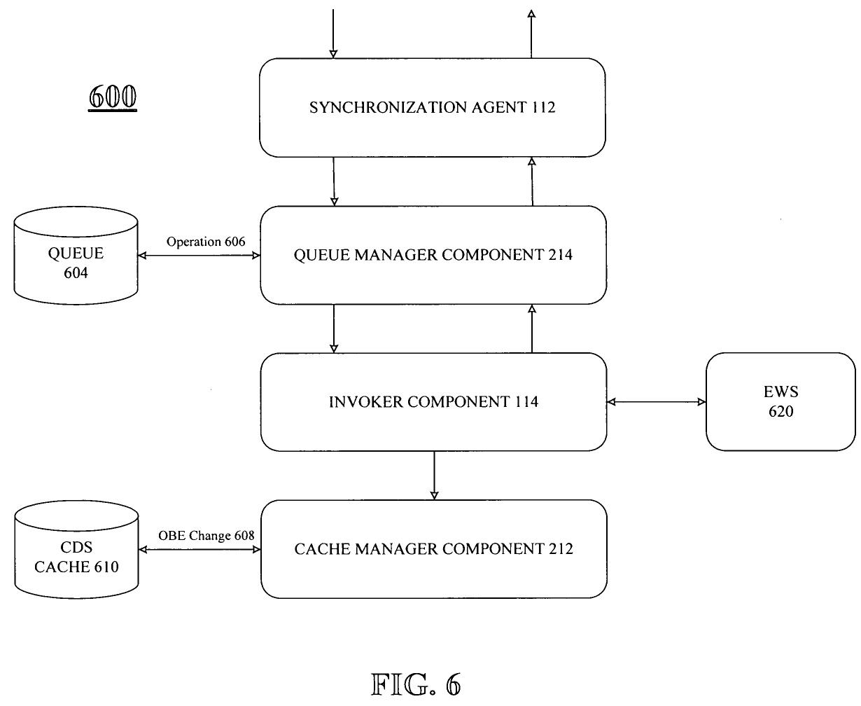

The synchronization agent component 112 is responsible for operation synchronization by executing the queued operations against the LOB application system 150, and for refreshing the CDS cache 222. The synchronization agent component 112 may be used to execute the CRUDQ and non-CRUDQ operations in the LOB application system 150 thru the middle-tier LOB server 130, as described in more detail with reference to FIG. 6.

FIG. 6 illustrates one embodiment of synchronizing operations performed by the synchronization agent component 112. The synchronization agent component 112 uses three of the offlining components to execute operations and cache the results. For example, the synchronization agent component 112 calls the queue manager component 214 to start executing an operation. The synchronization agent component 112 links the queue manager component 214, the invoker component 114, and the cache manager component 212 in that order to initialize the synchronization agent component 112. Once the synchronization agent component 112 starts it will call the queue manager component 214 to get operations that could be executed. An operation could be executed if all the previously queued operations for that entity have been successfully executed and they are in a “completed” state, and the entities on which it is dependent on are created where there is an entity ID available. For all the operations returned by the queue manager component 214, the synchronization agent component 112 calls a function in the queue manager component 214 to execute the operation. Execution of the operation will be done in a thread and the synchronization agent component 112 can use the thread pool for managing the threads.

The synchronization agent component 112 follows the “Work Offline” setting which could be set to prevent synchronizing changes to the LOB application system 150. If the Work Offline setting is set to ON, then flushing the queue 604 does not do anything. If there are no executable operations available in the queue 604, the queue flushing process waits for any operations to be added to the queue 604 or for a predefined period of time as defined in the registry. After the synchronization agent component 112 gets the list of executable operations from the queue manager component 214, the synchronization agent component 112 checks to see if the EWS 620 is reachable via the invoker component 114, before executing the operation. If the EWS 620 of all the executable operations returned is not reachable, the synchronization agent component 112 sets a connectivity change listener on the EWS 620. This functionality to detect connectivity changes of the EWS 620 is provided by the invoker component 114.

In various embodiments, the invoker component 114 may be used to call the EWS 620 to commit user changes against the LOB application system 150. One of the purposes of the synchronization agent component 112 is to execute the queued operations against the LOB application system 150 through the middle-tier LOB server 130. The middle-tier server 130 exposes a set of web services for doing CRUDQ operations on entity and view instances, and the synchronization agent component 112 needs to call the web services to commit the user changes against the LOB application system 150. The synchronization agent component 112 may call the web services via the invoker component 114.

The invoker component 114 may be arranged to communicate with any web service provided by the EWS 620. Before calling a web service function through the invoker component 114, the invoker component 114 should be aware of the web services provided by the EWS 620. More particularly, the invoker component 114 needs to know about the functions that are exposed by the web service, and for each function it needs to know about the arguments taken by the web service. Once the invoker component 114 is initialized or configured with a given web service, any function exposed in the web service could be called by passing the right parameters. The invoker component 114 may expose a generic interface which takes in the name of the function to be called and the list of arguments. The list of arguments may be passed, for example, as an object array. The invoker component 114 may handle converting the parameters into the type expected by the function, creating a Simple Object Access Protocol (SOAP) message and calling the function. SOAP is a protocol for exchanging XML-based messages over a computer network, normally using the Hypertext Transfer Protocol (HTTP). Return values and the list of out and in_out parameters from the function is made available to the caller.

The invoker component 114 should be configured before it could be used to call web service functions. To configure the invoker component 114 with a web service, a Web Services Description Language (WSDL) of the web service is needed. WSDL is an XML format published for describing web services. From the WSDL a service endpoint is created. The service endpoint represents the endpoint for a service that allows clients of the service to find and communicate with the service. The end point also contains the web service contract that is honored by the web service, and the contract specifies what functions the service exposes and the arguments for each function. Once the invoker component 114 is configured with the Uniform Resource Locator (URL) of the web service, the invoker component 114 knows about the functions and arguments of the functions of the given web service. The invoker component 1114 may also have a channel factory that could be used to create channels through which messages could be exchanged.

After the invoker component 114 is configured, it knows about the functions exposed by the service and could be used to call those functions. A caller could pass the name of the function to be called and the arguments to that function are sent as an object array. The arguments need to be present in the order in which they are specified in the function signature, for example, a value of the 0^{th} element of the array will become the first parameter of the function. The invoker component 114 will check the name and serialize each parameter value to an XML element which also includes the name of the parameter.

Once the name is checked and the parameter values are serialized, a function referred to as blind call is called and it handles executing the function by getting a channel to the service and sending the request message to the service. The return value from the request message is an XML document that contains the return value and the values of all the ref/out parameters. The XML document that is returned is then read to get the return value, value of ref/out parameters and they are stored in a dictionary and returned to the caller.

The invoker component 114 needs to be configured once per web service before usage. The synchronization agent component 112 maintains a mapping of web service URLs to invoker component objects. Before calling a web service function, we will check to see if there is an invoker component object for it. If there is no invoker component object available, an invoker component object is created and configured with the web service URL. The web service function is then executed by calling the invoke operations as previously described.

In various embodiments, the invoker component 114 may include logic to perform intelligent handling of version changes in the metadata descriptions for EWS and the entity model. If the EWS and/or entity metadata definitions change in a backward compatible way, the invoker component 114 may recognize that there has been a version change, obtain the latest version of the metadata that describes the EWS/entity, and formulate subsequent calls based on that latest description instead of continuing to use the previous description. In this manner, the invoker component 114 does not necessarily need to be re-configured when changes to metadata are made.

In addition to executing the queued operations against the LOB application system 150 thru the middle-tier LOB server 130, the synchronization agent component 112 is also responsible for refreshing the cache 610 using the subscriptions set in the system. Cache refresh subscriptions could be set at three levels, including a view based, entity based and query based level. One purpose of the refresh handling component of the synchronization agent component 112 is to find subscriptions to be refreshed and get new data from the LOB application system 150.

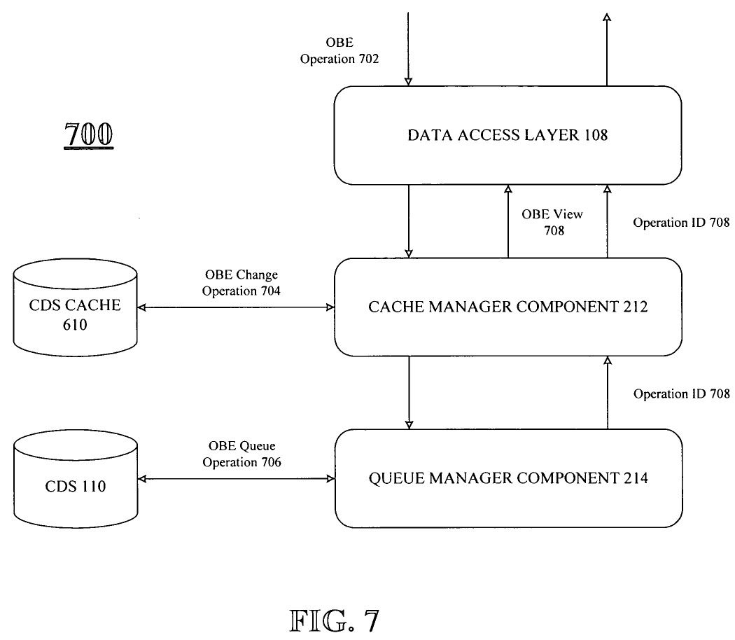

FIG. 7 illustrates how the cache manager component 212 and the queue manager component 214 are used in an offline operation execution mode. When the DAL 108 executes operations on entity instances, changes are done locally and the operation is queued. Even though changes are done locally, when the operation is done in the LOB application system 150, the state of the data will not be the same as what is stored in the cache. When a read is done on a view instance that does not exist, the queue manager component 214 queues the operation and the DAL 108 needs to know when the view instance has been read from the LOB application system 150. Similarly for non-CRUDQ operations, the DAL 108 needs to know when the operation has been completed. Two different types of notifications may be implemented, the first type from the components 212, 214 to the DAL 108, and the second type for non-CRUDQ operations and changes in view instances. The DAL 108 should receive notifications for at least 3 kinds of data, including changes to view instances, changes to operations and changes to ID fix up information. In addition, the DAL 108 could receive additional notifications, including changes to individual rows (e.g., change to view instance), and changes to operation state and notifications at table level. Notification for CID-EID fix up information is an example of a case where the DAL 108 needs notifications for changes at a table level. Notifications for table level changes work on tables that have a timestamp column. When a table has a column of type timestamp, a change to any row will bump up the value of the timestamp column of that row. When applications call the DAL 108 API for changes, they will get the timestamp of each row and they have to keep track of the highest timestamp they have seen. When they ask again for the changes, they have to pass in the highest timestamp and they will get any changes with a timestamp value greater than the timestamp they passed.

Operations for the enterprise system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the enterprise system 100 or alternative elements as desired for a given set of design and performance constraints.

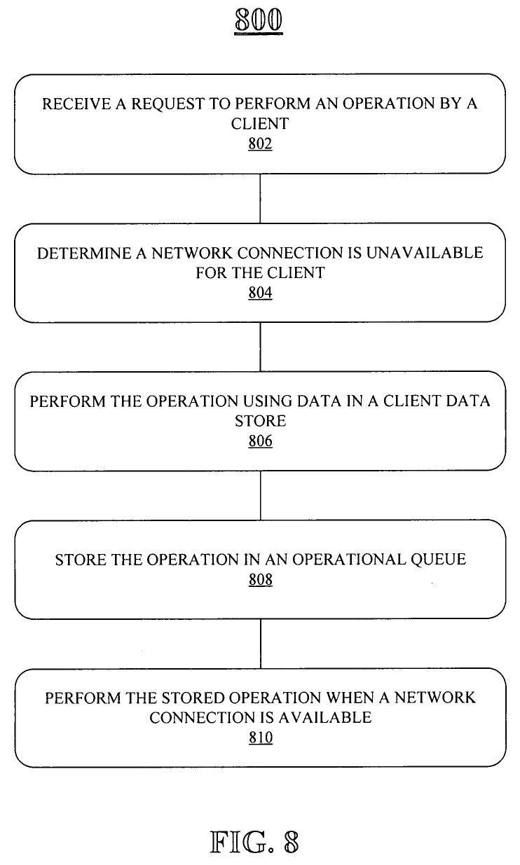

FIG. 8 illustrates a logic flow 800. The logic flow 800 may be representative of the operations executed by one or more embodiments described herein. As shown in FIG. 8, the logic flow 800 may receive a request to perform an operation (228) by a client (102) at block 802. The logic flow 800 may determine a network connection is unavailable for the client (102) at block 804. The logic flow 800 may perform the operation (228) using data in a CDS (110) at block 806. The logic flow 800 may store the operation (228) in an operational queue (226) at block 808. The logic flow 800 may perform the stored operation when a network connection is available at block 810. The embodiments are not limited in this context.

FIG. 9 illustrates a block diagram of a computing system architecture 900 suitable for implementing various embodiments, including the various elements of the enterprise system 100. It may be appreciated that the computing system architecture 900 is only one example of a suitable computing environment and is not intended to suggest any limitation as to the scope of use or functionality of the embodiments. Neither should the computing system architecture 900 be interpreted as having any dependency or requirement relating to any one or combination of components illustrated in the exemplary computing system architecture 900.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 9, the computing system architecture 900 includes a general purpose computing device such as a computer 910. The computer 910 may include various components typically found in a computer or processing system. Some illustrative components of computer 910 may include, but are not limited to, a processing unit 920 and a memory unit 930.

In one embodiment, for example, the computer 910 may include one or more processing units 920. A processing unit 920 may comprise any hardware element or software element arranged to process information or data. Some examples of the processing unit 920 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 920 may be implemented as a general purpose processor. Alternatively, the processing unit 920 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 910 may include one or more memory units 930 coupled to the processing unit 920. A memory unit 930 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 910. The embodiments are not limited in this context.

In one embodiment, for example, the computer 910 may include a system bus 921 that couples various system components including the memory unit 930 to the processing unit 920. A system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 910 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 900. Examples of computer readable media for computing system architecture 900 may include, but are not limited to, volatile and/or nonvolatile memory such as ROM 931 and RAM 932. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 930 includes computer storage media in the form of volatile and/or nonvolatile memory such as ROM 931 and RAM 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor 991, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer (PC), a server, a router, a network PC, a peer device or other common network node, and typically includes many or all of the elements described above relative to the computer 910, although only a memory storage device 981 has been illustrated in FIG. 9 for clarity. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other technique suitable for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other techniques for establishing a communications link between the computers may be used. Further, the network connections may be implemented as wired or wireless connections. In the latter case, the computing system architecture 900 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the managed taxonomy entity model system 100 and/or computing system architecture 900 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously provided for the memory unit 130. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. It is worthy to note that although some embodiments may describe structures, events, logic or operations using the terms “first,” “second,” “third,” and so forth, such terms are used merely as labels, and are not intended to impose numerical requirements on their objects. Further, such terms are used to differentiate elements and not necessarily limit the structure, events, logic or operations for the elements.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a request to perform an operation by a client;
determining a network connection is unavailable for said client;
performing said operation using data in a client data store;
storing said operation in an operational queue; and
performing said stored operation when a network connection is available.

2. The method of claim 1, comprising receiving said request to perform said operation on data for an office business entity.

3. The method of claim 1, comprising receiving said request to perform a create operation, read operation, update operation, delete operation, or query operation by said client.

4. The method of claim 1, comprising assigning a correlation identifier representing a temporary identifier for said entity.

5. The method of claim 1, comprising mapping a correlation identifier representing a temporary identifier for said entity to an entity identifier representing a permanent identifier for said entity.

6. The method of claim 1, comprising returning a result for said operation to said client.

7. The method of claim 1, comprising storing a result for said operation.

8. The method of claim 1, comprising receiving a query for a stored result for said operation.

9. The method of claim 1, comprising:
grouping stored operations by a correlation identifier;
detecting said network connection; and
invoking said stored operations in sequence by group.

10. The method of claim 1, comprising:
merging contiguous operations for a group to form a merged operation;
detecting said network connection; and
invoking said merged operation.

11. An article comprising a storage medium containing instructions that if executed enable a system to:
receive a request to perform an operation for an office business entity;
determine a network connection is unavailable for a client device;
perform said operation using data in a client data store;
store said operation in an operational queue; and
invoke said stored operation when a network connection is available.

11. The article of claim 10, further comprising instructions that if executed enable the system to receive said request to perform a create operation, read operation, update operation, delete operation, or query operation by said client.

12. The article of claim 10, further comprising instructions that if executed enable the system to map a correlation identifier representing a temporary identifier for said entity to an entity identifier representing a permanent identifier for said entity.

13. The article of claim 10, further comprising instructions that if executed enable the system to return a result for said operation to said client.

14. The article of claim 10, further comprising instructions that if executed enable the system to:
store a result for said operation; and
receive a query for a stored result for said operation.

15. The article of claim 10, further comprising instructions that if executed enable the system to merge contiguous operations for a group to form a merged operation.

16. An apparatus comprising a client device having an application program, a data access layer, and a client data store, said data access layer comprising a cache manager component and a queue manager component, said application program to request an operation for an office business entity, said cache manager component to perform said operation using data stored by said client data store, and said queue manager component to store said operation in an operational queue.

17. The apparatus of claim 16, comprising an invoker component to invoke said an electronic web server to perform said operation, and return results for said operation to said application program.

18. The apparatus of claim 16, comprising an authenticate component to authenticate a user to access data stored by said client data store.

19. The apparatus of claim 16, comprising a security component to encrypt and decrypt data stored by said client data store.

20. The apparatus of claim 16, comprising a synchronization agent component and a network interface, said client device to establish a network connection with a server using said network interface, and said synchronization agent component to synchronize performance of operations stored in said operational queue using data stored by a server data store.
